(19) United States
(12) Patent Application Publication
(10) Pub. No.: US 2010/0102007 A1
(43) Pub. Date: Apr. 29, 2010

(54) Process for Treatment of Sewage Waste Water

(76) Inventor: Abdel Magid Kalo, Beirut (LB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/257,176

(22) Filed: Oct. 23, 2008

(51) Int. Cl. C02F 1/52; C02F 1/78

(52) U.S. Cl. 210/721; 210/760; 210/723

(57) ABSTRACT

This is a reliable cost-effective adsorption based method for removing the dissolved and suspended organic matter by adding a natural “flocculent sorption particles” which is (Sodium, Calcium, Alumino silicate hydrated), and ferric Chloride, using a mixing tank. Heavy Macro-particles are formed that can be gravity separated and easily dewatered. The supernatant is first treated by OZONE to reduce the remaining organic pollutants and kill the bacteria, then filtered through a single layer of filter media. The suspended solids are mechanically strained down to 3-5 microns.

The effluent water quality will be conform, or better, to the official water discharge standards.

### TECHNICAL FIELD

The present invention relates to a flocculation precipitation treatment comprising adding flocculent to raw water to flocculate and precipitate suspended and dissolved substances in treating sewage, waste water, river water increased in pollution, lake . . . etc.

### DISCLOSURE OF THE INVENTION

The present invention provides a method of flocculation precipitation treatment of a solution obtained by adding an inorganic flocculent to raw water and mixing and slowly agitating the solution and introducing the agitated solution to a settling tank where flocs are allowed to settle and solid-liquid separation is effected and simultaneously the separated water is discharged out of the tank.

Gravity sedimentation is used to “thicken” the sludge to about 2.5%-3% solids. The resulting decant water is recycled back to the plant for reprocessing. The current procedure for sludge dewatering is to add aluminum sulfate and polymer. Aluminum sulfate contains aluminum and polymer adds “water of hydration” to sludge hence limit the dewatering process. The objective is to achieve the maximum sludge dewatering and to haul off more sludge and less water. The dried sludge can be used as soil additive for agriculture use or municipality parks . . . etc.

In this present invention, there is the addition of two chemicals: flocculent and ferric chloride. Flocculent is added to water in a tank (2) equipped with a slow speed electric agitator (4) to make a suspension. This suspension is pumped by means of a variable speed dosing pump (6) to the sewage inflow pipe (1) at a dosing that should be adjusted to have optimal performance, (100-170 g/m3 of sewage water). The flocculent is a natural mineral ore sorbent powder used for its high efficiency for removing the organic matter, suspended solids and colloids, based on ion-exchange, surface adsorption and nucleation reactions. The inert flocculent particles function as absorption and nucleation “bodies” analogous to a crystallization reaction that undergo charges layering to form macro-particles with specific gravity range of 1.2-1.4.

Ferric Chloride is added to a water in a tank (3) equipped with a slow speed electric agitator (5) to make a solution. This solution is pumped by means of a variable speed dosing pump (7) to sewage inflow pipe (1) at dosing that should be adjusted to have optimal performance, (20-30 g/m3 of sewage water).

Iron treatment with the flocculent circumvents the aluminum toxicity issue and achieves a good floc and has a high binding affinity for the flocculated particles.

The pipe (1) having the mixture of the flocculent and ferric chloride goes to mixing tank (9) equipped with a low speed electric agitator (8), where the agitation time is 4-7 minutes. Flocs start to appear in this tank (9). The water with flocs flows through a pipe (10) from this tank to the settling tank (12).

The coagulated flocs having a specific gravity of 1.2-1.4 settle down rapidly to the bottom of the settling tank (12) forming a stable sludge. The settling tank (12) has a baffle plate (17a) to reduce the turbulence and settling tank (12) is sized in a way that the settling velocity of the flocs is higher than the velocity of the raw sewage inflow water. This can be accomplished by regulating the discharge flow rate of the sewage inlet pump. The settling tank (12) is equipped with a moving scraper (16) equipped with siphons to collect and discharge the sludge as a concentrated slurry (17) to the thickener tank (19). The water from which flocs have been removed by settling in tank (12) flows in the longitudinal collection channel (13) and pipe (14) and discharged as clarified water in the ozone treatment tank (23). Ozone production unit (21) delivers ozone through pipe (22) and mixed with clarified water in pipe (22a). This mixture water flows in the ozone treatment tank (23) equipped with baffles (25) to make efficient contact between ozone and dissolved organics. Retention time in this tank (23) is 8 minutes.

Due to the reaction of ozone with the dissolved organic matter, some new_flocs are formed. The outlet water from this tank (23) with the flocs flows through pipe (24) to the filter (26) having a single filtration media for final filtration.

The filtered water flows out of the filter (26) through pipe (28) for use in irrigation, industries . . . etc.

The filter backwash water flows through pipe (29) to thickener tank (19).

The thickened sludge in the thickener (19) drawn in pipe (20) and will either be sent to belt press for more dewatering or directly for use as excellent soil additive.

### BRIEF DESCRIPTION OF THE DRAWINGS

FIG. 1: is a constitutional diagram of chemicals solution tanks, mixing tanks and chemical dosing pumps.

FIG. 2: is a section drawing of the settling tank, sludge scrapper and decant water overflow.

FIG. 3: is a cross section drawing of sludge thickener tank.

FIG. 4: is a cross section drawing of Ozone treatment tank and the sand filter.

### MODE FOR CARRYING OUT THE INVENTION

The present invention will be explained in detail with the use of the drawings.

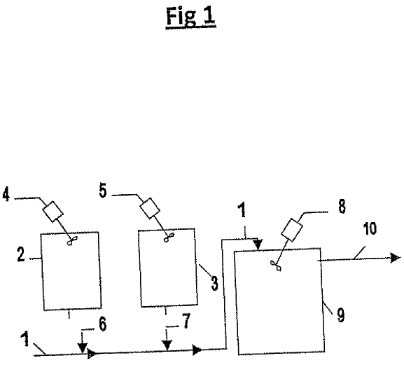

In FIG. 1:

Numeral

1—is an influent raw water pipe (water to be treated)

6, 7—are chemical solution dosing pumps

4, 5, 8—electric mixers of chemicals

2, 3, 9—focculent and ferric chloride chemicals mixing tanks.

10—floc transfer pipe to clarifier.

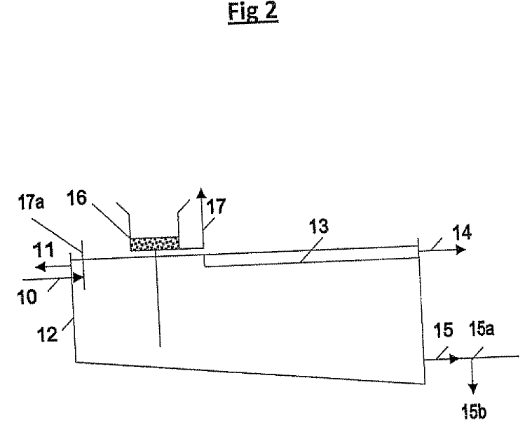

In FIG. 2:

Numeral

11—is a scum carrying pipe

12—is a clarifier tank

13—is a decant water over flow to screen channel

14—is a decant water carrying pipe

15—is a sludge discharge pipe going to pipe numeral 15a and pipe numeral 15b.

15a—is a sludge discharge pipe going to sludge thickener numeral 19.

15b—is a tank waste washing water pipe going to drain.

16—is a moving sludge scrapper

17—sludge outlet going to thickener tank numeral 19

17a—baffle

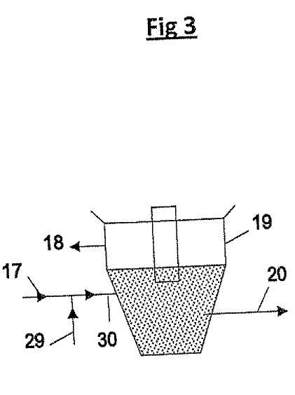

In FIG. 3:

Numeral

17—sludge pipe collection coming from thickener tank numeral 19

18—pipe carrying light sludge to inlet water screen channel

19—sludge thickener tank

20—thickened sludge pipe to end user or to belt press

29—backwash water flow from filter numeral 26

30—collected sludge pipe of sludge pipe numeral 17 and backwash water from filter numeral 29

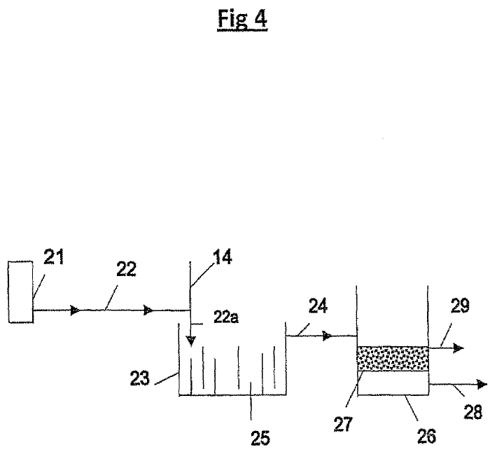

In FIG. 4:

Numeral

14—is decant water pipe

21—is ozone generator

22—ozone feed pipe to ozone treatment tank numeral 23

22a—a pipe of mixture of numeral 14 and numeral 22

23—ozone treatment tank

24—carrying pipe of ozone treated water from tank numeral 23 to filter numeral 26

25—P.E baffles

26—decant water filter tank

27—single filter media

28—filtered water pipe to end user

29—Back wash water pipe to thickener numeral 19

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Lebanese application No. 8181, filed Jan. 30, 2008 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for treating sewage waste water, comprising the following:
mixing the sewage waste water with flocculent sorption particles of sodium, calcium, alumino silicate hydrated and ferric chloride to form macro-particles that can be gravity separated and dewatered to 30% solids,
feeding the mixture of sewage waste water, flocculent sorption particles and ferric chloride to a settling tank,
treating the decant water within the settling tank with ozone to further reduce the residual dissolved organic matter and kill bacteria,
filtering the ozone treated water through a single media which is sodium, calcium alumino silicate hydrated to obtain a filtrate of water with suspended particles of 5 microns or less.
